(19) United States
(12) Patent Application Publication
(10) Pub. No.: US 2014/0226616 A1
(43) Pub. Date: Aug. 14, 2014

(54) METHOD AND DEVICE FOR DETECTING CONTROL CHANNEL IN MULTI-NODE SYSTEM

(71) Applicant: LG ELECTRONICS INC., Seoul (KR)

(72) Inventors: Bin Chul Ihm, Anyang-si (KR); Ki Tae Kim, Anyang-si (KR); Su Nam Kim, Anyang-si (KR); Ji Won Kang, Anyang-si (KR); Jin Young Chun, Anyang-si (KR); Sung Ho Park, Anyang-si (KR)

(21) Appl. No.: 14/351,445

(22) PCT Filed: Oct. 12, 2012
(86) PCT No.: PCT/KR2012/008347

§ 371 Date: Apr. 11, 2014

Related U.S. Application Data
(60) Provisional application No. 61/547,042, filed on Oct. 14, 2011.
(60) Provisional application No. 61/559,727, filed on Nov. 15, 2011.

(51) Int. Cl. H04W 72/04

(52) U.S. Cl. CPC H04W 72/0406
USPC 370/329

(57) ABSTRACT

Provided are a method and a device for searching for a control channel of a terminal in a multi-node system. Said method comprises the steps of: receiving user equipment specific reference signal (URS) setting information for setting URSs in a first area and a second area which are divided according to a resource allocation method, wherein said first area is a non-interleaving area in which channels are allocated to local radio resources, and said second area is an interleaving area in which channels are allocated to distributed radio resources; and searching for a control channel in said first area, wherein said user equipment attempts to detect said control channel by using each of a plurality of candidate URSs which can be set by said URS setting information.

### BACKGROUND OF THE INVENTION

1. Field of the invention

The present invention relates to wireless communication, and more particularly, to a method and device for detecting a control channel in a multi-node system.

2. Related Art

Recently, the amount of transmission of data of a wireless communication network is on a rapid increase. This is because various devices such as a smart phone and a tablet PC which require machine-to-machine (M2M) communication and a large amount of data transmission appear and are distributed. In order to satisfy the high amount of transmission of data, a carrier aggregation technology which efficiently uses more frequency bands, a cognitive radio technology, etc., are drawing attention, and in order to increase the data capacity within limited frequencies, a multi-antenna technology, a multi base station cooperation technology, etc. are drawing attention.

Furthermore, the wireless communication network is evolving in a direction that the density of nodes, which may have an access to the area around the user, increases.

Here, a node may refer to an antenna or antenna group which is placed away by more than a certain interval from a distributed antenna system (DAS), but the meaning of the node may be extended. That is, the node may be a base station (PeNB), a home base station (HeNB), a remote radio head (RRH), a remote radio unit (RRU), a relay, etc. The wireless communication system may show a higher system performance by cooperation between nodes. That is, if each node operates like an antenna or antenna group for one cell by transmission and reception management by one control station, a much superior system performance may be shown. Hereinafter, a wireless communication including a plurality of nodes is called a multi-node system.

A node may be applied even if defined not only as an antenna group which is placed away by more than a certain interval, but also as an arbitrary antenna group regardless of an interval. For example, the base station composed of a closs polarized antenna may be formed of a node composed of a H-pol antenna and a node composed of a V-pol antenna.

Furthermore, in a multi-node system, a new control channel may be used due to inter-cell interference an insufficient capacity in the existing control channel, etc. In the existing control channel, decoding was possible based on a cell-specific reference signal (CRS) which may be received by all user equipments (UEs), but in a new control channel, decoding may be possible based on a user equipment-specific reference signal (URS).

The new control channel may be allocated to the data region among the control region and the data region in the subframe. In this case, the new control channel may be allocated to a wireless resource region to which two difference resource allocation schemes including non-interleaving and interleaving are applied. At this time, the scheme, in which the URS, which may be used in decoding a new control channel in another wireless resource region, is provided, is an issue. From the perspective of the UE, the way, in which a new control channel is to be searched and decoded using which URS, is an issue.

### SUMMARY OF THE INVENTION

An object of the present invention is to provide a method and apparatus for detecting a control channel and providing a reference signal used in decoding in a multi-node system, and detecting and decoding a control channel by using the reference signal.

In accordance with an aspect of the present invention, a method of detecting for a control channel of a user equipment (UE) in a multi-node system includes: receiving UE-specific reference signal (URS) configuration information, the URS configuration information configuring a URS in a first region and a second region which are distinguished according to a resource allocation scheme; and searching for a control channel in the first region, wherein the first region is a non-interleaving region where a channel is allocated to a local radio resource, and the second region is an interleaving region where a channel is allocated to a distributed radio resource, and wherein the UE attempts to detect the control channel using each of a plurality of candidate URSs which can be configured by the URS configuration information.

In accordance with another aspect of the present invention, a user equipment

(UE) for detecting of a control channel in a multi-node system includes a radio frequency (RF) unit which transmits and receives a wireless signal, and a processor which is connected to the RF unit, wherein the processor is configured for: receiving UE-specific reference signal (URS) configuration information, the URS configuration information configuring a URS in a first region and a second region which are distinguished according to a resource allocation scheme; and searching for a control channel in the first region, wherein the first region is a non-interleaving region where a channel is allocated to a local radio resource, and the second region is an interleaving region where a channel is allocated to a distributed radio resource, and wherein the UE attempts to detect the control channel using each of a plurality of candidate URSs which can be configured by the URS configuration information.

The E-PDCCH allocated to a region with a different resource allocation scheme may be efficiently detected and decoded. The decoding performance of the PDSCH is improved because the multiplexing in the space level of the PDSCH, which is scheduled by the E-PDCCH, may be recognized through the reference signal used in the detection of the E-PDCCH.

### BRIEF DESCRIPTION OF THE DRAWINGS

FIG. 1 shows an example of a multi-node system.

FIG. 2 shows a structure of a downlink wireless frame in a 3GPP LTE-A.

FIG. 3 shows an example of a resource grid for one downlink slot.

FIG. 4 shows an example of RB to which URS is mapped and shows DM-RS as an example of the URS.

FIG. 5 shows an example of E-PDCCH.

FIG. 6 shows an example of an existing R-PDCCH.

FIG. 7 shows an example of separating and allocating a DL grant and a UL grant for each slot.

FIG. 8 shows an example of simultaneously allocating a DL grant and a UL grant for a first slot.

FIG. 9 shows an example of interleaving of E-PDCCH.

FIG. 10 shows an example where a non-interleaving region and an interleaving region are divided in slot units in E-PDCCH region.

FIG. 11 shows a scheme of searching for E-PDCCH of a UE according to an embodiment of the present invention.

FIG. 12 is a block diagram showing a wireless device to which an embodiment of the present invention may be applied.

### DESCRIPTION OF EXEMPLARY EMBODIMENTS

A user equipment (UE) may be fixed or mobile, and may also be called a mobile station (MS), a mobile terminal (MT), a user terminal (UT), a subscriber station (SS), a wireless device, a personal digital assistant (PDA), a wireless modem, a handheld device, etc.

A base station generally refers to a fixed station which communicates with a UE, and may also be called an evolved-NodeB (eNB), a base transceiver system (BTS), an access point, etc.

Hereinafter, the application of the present invention based on the 3GPP LTE based on 3^{rd} generation partnership project (3GPP) technical specification (TS) release 8 and 3GPP LTE-A based on 3GPP TS release 10 will be described. However, these are merely examples, and the present invention may be applied to various wireless communication networks.

In order to improve the performance of the wireless communication system, the technology is evolving in a direction that increases the density of the node which may be connected to the area around the user. The performance of the wireless communication system with a high node density may be improved by cooperation between nodes.

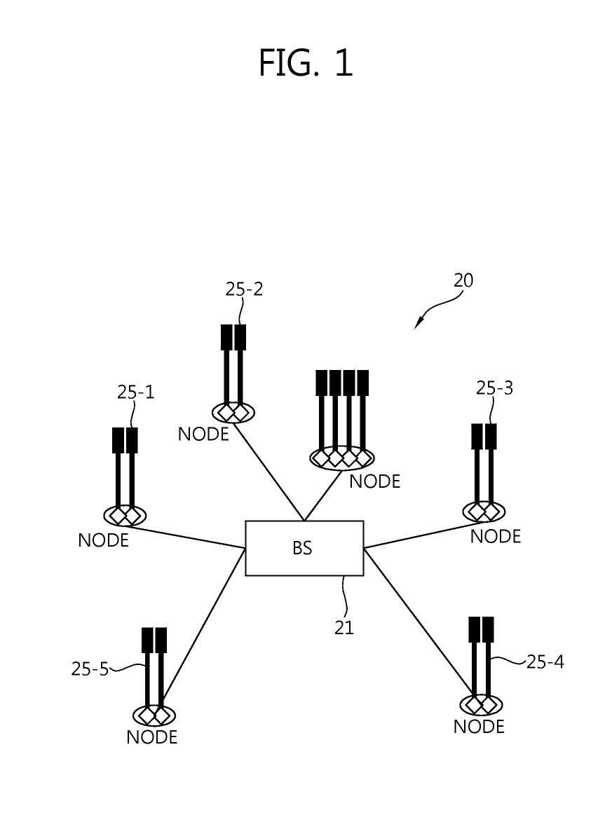

FIG. 1 shows an example of a multi-node system.

Referring to FIG. 1, the multi-node system 20 may include one base station 21 and a plurality of nodes 25-1, 25-2, 25-3, 25-4, and 25-5. The plurality of nodes 25-1, 25-2, 25-3, 25-4, and 25-5 may be managed by one base station 21. That is, the plurality of nodes 25-1, 25-2, 25-3, 25-4, and 25-5 may operate as if they were a part of one cell. At this time, each node 25-1, 25-2, 25-3, 25-4, or 25-5 may be allocated a separate node ID or may operate like some antenna groups within the cell without a separate node ID. In such a case, the multi-node system 20 of FIG. 1 may be considered as a distributed multi-node system (DMNS) which forms one cell.

Furthermore, a plurality of nodes 25-1, 25-2, 25-3, 25-4, and 25-5 may perform scheduling and handover (HO) of the UE without individual cell IDs. In such a case, the multi-node system 20 of FIG. 1 may be considered as a multi-cell system. The base station 21 may be a macro cell, and each node may be a femto cell or a pico cell having a cell coverage smaller than a cell coverage of the macro cell. Likewise, when the plurality of cells are overlaid according to the coverage, the network may be called a multi-tier network.

In FIG. 1, each node 25-1, 25-2, 25-3, 25-4, or 25-5 may be one of a base station, a Node-B, an eNode-B, a pico cell eNb (PeNB)), a home eNB (HeNB), a radio remote head (RRH), a relay station (RS) or repeater, and a distributed antenna. At least one antenna may be installed at one node. Furthermore, the node may be called a point. In the specification below, the node refers to an antenna group which is placed away by more than a certain interval from the DMNS. That is, it is assumed below that each node physically refers to RRH. However, the present invention is not limited to this example, and the node may be defined as an arbitrary antenna group regardless of the physical interval. For example, the base station, which is composed of a plurality of cross polarized antennas, may be formed of a node composed of horizontal polarized antennas and a node composed of vertical polarized antennas. The present invent may also be applied to the case when the cell coverage of each node is a small pico cell or a femto cell, i.e., the multi-cell system. In the description below, the antenna may be substituted by an antenna port, a virtual antenna, an antenna group, etc. as well as a physical antenna.

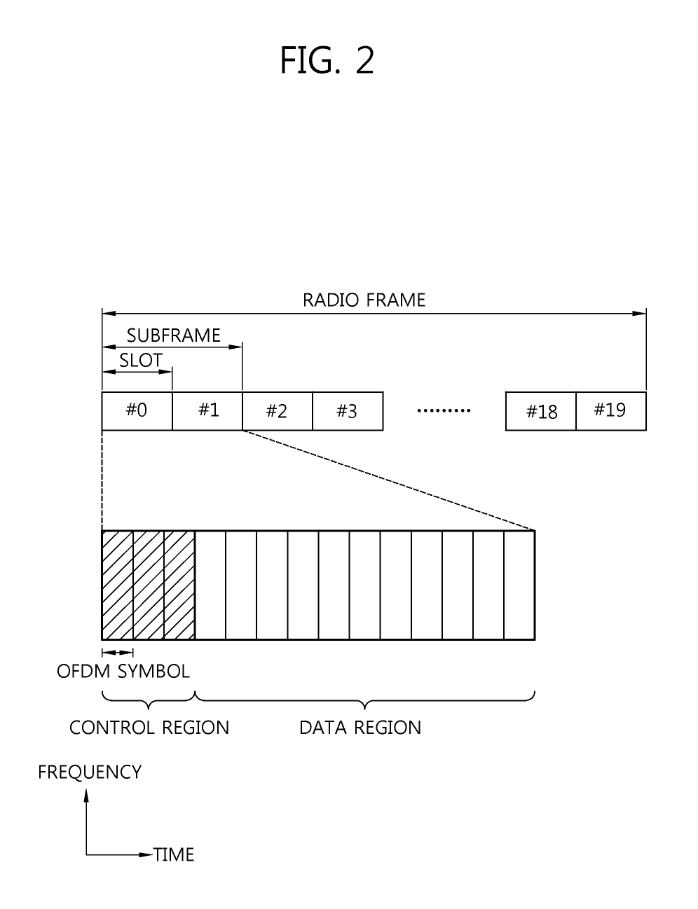

FIG. 2 shows a structure of a downlink wireless frame in a 3GPP LTE-A. For this, section 6 of 3GPP TS 36.211 V10.2.0 (2011-06) “Evolved Universal Terrestrial Radio Access (E-UTRA); Physical Channels and Modulation (Release 10)” may be referred to.

A radio frame includes 10 subframes having indexes 0 to 9. One subframe includes two consecutive slots. The time, which takes in transmission of one subframe, is called a transmission time interval (TTI). For example, the length of one subframe may be 1 ms, and the length of one slot may be 0.5 ms.

One slot may include a plurality of orthogonal frequency division multiplexing (OFDM) symbols. The OFDM symbol uses an orthogonal frequency division multiple access (OFDMA) in DL, and thus it is only to express one symbol period in the time domain and there is no limitation in the multiplexing scheme or name. For example, the OFDM symbol may be called as another name such as a single carrier-frequency division multiple access (SC-FDMA) or a symbol period.

It is illustrated that one slot includes 7 OFDM symbols, but the number of OFDM symbols included on slot may be changed depending on the length of the cyclic prefix (CP). According to 3GPP TS 36.211 V10.2.0, 1 slot in the normal CP includes 7 OFDM symbols, 1 slot in the extended CP includes 6 OFDM symbols.

The resource block (RB) is a resource allocation unit, and includes a plurality of subcarriers in one slot. For example, if one slot 7 OFDM symbols in the time domain and the RB includes 12 subcarriers in the frequency domain, one RB may include 7×12 resource elements (REs).

The DL subframe is divided into a control region and a data region in the time domain. The control region includes the maximum 4 OFDM symbols before the first slot within the subframe, but the number of OFDM symbols included in the control domain may be changed. The physical downlink control channel (PDCCH) and other control channels are allocated to the control region, and the DPSCH is allocated to the data region.

As disclosed in 3GPP TS 36.211 V10.2.0, in 3GPP LTE/LTE-A, the physical channel may be divided into physical downlink shared channel (PDSCH) and physical uplink shared channel (PUSCH) which are data channels, and physical downlink control channel (PDCCH), physical control format indicator channel (PCFICH), physical hybrid-ARQ indicator channel (PHICH), and physical uplink control channel (PUCCH) which are control channels.

The PCFICH, which is transmitted in the first OFDM symbol of the subframe, carries the control format indicator (CFI) about the number of OFDM symbols (i.e., the size of the control region) used in the transmission of control channels within the subframe. The UE first receives CFI on the PCFICH and monitors PDCCH.

Unlike PDCCH, the PCFICH is transmitted through the fixed PCFICH resource of the subframe without using blind decoding.

The PHICH carries the positive-acknowledgement(ACK)/negative-acknowledgement(NACK) for hybrid automatic repeat request (HARQ). The ACK/NACK signal about the UL data on the PUSCH transmitted by the UE is transmitted on the PHICH.

The physical broadcast channel is transmitted in 4 OFDM symbols before the second slot of the first subframe of the wireless frame. The PBCH carries system information which is essential in communication between the UE and the base station, and the system information transmitted through the PBCH is called a master information block (MIB). Furthermore, the system information, which is indicated by the PDCCH and is transmitted on the PDSCH, is called a system information block (SIB).

The control information transmitted through the PDCCH is called downlink control information (DCI). The DCI may include resource allocation of PDSCH (also called DL grant), resource allocation of PUSCH (also called UL grant), and activation voice over Internet protocol (VoIP) and/or a set of transmission power control commands for individual UEs within an arbitrary UE group.

In the 3GPP LTE, blind decoding is used for detection of PDCCH. The blind decoding is a scheme of demasking the desired identifier to the cyclic redundancy check (CRC) of the received PDCCH (called a candidate PDCCH) and checking the CRC error and checking whether the PDCCH is its own control channel.

After determining the PDCCH format according to the DCI which is to be sent to the UE, the base station attaches the CRC on the DCI and masks the unique identifier (called the radio network temporary identifier (RNTI)) with the CRC according to the owner or usage of the PDCCH.

The control region within the subframe includes a plurality of control channel elements (CCE). The CCE is a logical allocation unit used to provide the encoding rate according to the state of the wireless channel to the PDCCH, and corresponds to a plurality of resource elements groups (REGs). The REG includes a plurality of resource elements. The format of the PDCCH and the number of bits of possible PDCCH are determined according to the correlation between the number of CCEs and the encoding rate provided by the CCEs.

One REG includes 4 REs, and one CCE includes 9 REGs. In order to form one PDCCH, {1, 2, 4, 8} CCEs, and each element of {1, 2, 4, 8} is called CCE aggregation level.

The number of CCEs used in transmission of the PDDCH is determined by the base station according to the channel state. For example, one CCE may be used in PDCCH transmission in the UE having a good downlink channel state. 8 CCEs may be used in the PDCCH transmission in the UE having a poor downlink channel state.

The control channel, which is composed of one or more CCEs, performs interleaving in REG units, and is mapped with the physical resource after the cyclic shift based on the cell ID is performed.

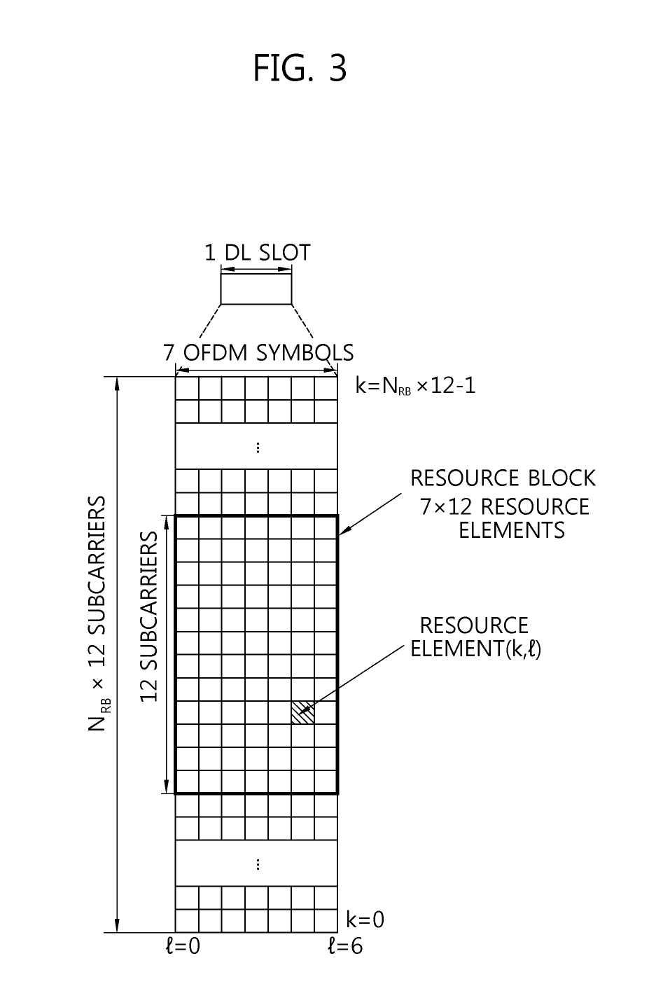

FIG. 3 shows an example of a resource grid for one downlink slot.

The downlink slot includes a plurality of OFDM symbols in the time domain, and includes N_{RB} resource blocks in the frequency domain. N_{RB}, which is the number of resource blocks included in the downlink slot, is dependent on the downlink transmission bandwidth which is set in the cell. For example, in the LTE system, the N_{RB} may be one of 6 to 110. One resource block includes a plurality of subcarriers in the frequency domain. The structure of the uplink slot may be the same as the structure of the downlink slot.

Each element on the resource grid is called a resource element (RE). The resource element on the resource grid may be identified by the index pair (k, l) within the slot. Here, k (k=0, . . . , N_{RB}×12-1) is the subcarrier index within the frequency domain, and 1 (1=0, . . . , 6) is the OFDM symbol index within the time domain.

Here, it is illustrated that one resource block includes 7 OFDM symbols in the time domain and includes 7×12 resource elements composed of 12 subcarriers in the frequency domain, but the number of OFDM symbols and subcarriers in the resource block is not limited thereto. The number of OFDM symbols and the number of subcarriers may be changed depending on the length of the CP and the frequency spacing, etc. For example, in the case of the normal CP, the number of OFDM symbols is 7, and in the case of the extended CP, the number of OFDM symbols is 6. In one OFDM symbol, the one of 128, 256, 512, 1024, 1536 and 2048 may be selected and used as the number of subcarriers.

Furthermore, various reference signals (RSs) are transmitted to the subframe. The cell-specific reference signal (CRS) may be received by all UEs within the cell, and is transmitted throughout the entire downlink bands. The CRS may be generated based on the cell ID. The UE-specific reference signal (URS) is transmitted in the subframe. The CRS is transmitted in the entire region of the subframe, but the URS is transmitted in the data region of the subframe and is used in the demodulation of the corresponding PDSCH. The URS is called demodulation RS (DM-RS). Hereinafter, the URS is described.

For antenna port 5, the URS sequence rns(m) is defined as the following equation.

$${r}_{{n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , 12 {N}_{RB}^{PDSCH} - 1 \qquad Equation 1$$

In equation 1, N^{PDSCH}_{RB} indicates the frequency band of the corresponding PDSCH transmission in resource block units.

The pseudo-random sequence is defined by the gold sequence of the following length 31.

c(n)=(x₁(n+Nc)+x₂(n+Nc)) mod 2

x₁(n+31)=(x₁(n+3)+x₁(n)) mod 2

x₂(n+31)=(x₂(n+3)+x₂(n+2)+x₂(n+1)+x₂(n)) mod 2 Equation 2

The pseudo-random sequence is initialized to cᵢₙᵢₜ=(|nₛ/2┘+1)·(2N_{ID}^{cell}+1)·2¹⁶+n_{RNTI} in the start of each subframe. Here, nRNTI denotes the radio network temporary identifier.

Furthermore, when the antenna port p is {7, 8, . . . , v+6}, the URS sequence r(m) may be defined as follows.

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix\end{matrix} \qquad Equation 3$$

The pseudo-random sequence is initialized to cᵢₙᵢₜ=(|nₛ/2┘+1)·(2N_{ID}^{cell}+1)·2¹⁶+n_{SCID} in the start of each subframe. The n_{SCID} is given in the most recent DCI format 2B or 2C associated with the PDSCH transmission according to the following table.

TABLE 1

| Scrambling identity field | |
|---|---|
| in DCI format 2B or 2C | n_{SCID} |
| 0 | 0 |
| 1 | 1 |

If there is no DCI format 2B or 2C associated with the PDSCH transmission of antenna port 7 or 8, the UE assumes that n_{SCID} is 0.

The UE assumes that n_{SCID} is 0 for antenna ports 9 to 14.

The URS supports the PDSCH transmission, and is transmitted in antenna port p=5, p=7, p=8 or p=7,8, . . . , v+6. Here, “v” denotes the number of layers used in transmission.

The URSs may be transmitted one UE through antenna ports included in set S. S={7,8,11,13}, or S={9,10,12, 14}.

For antenna port p=7, p=8, p=7,8, . . . , v+6, the physical resource block having frequency domain index n_{PRB} is allocated for PDSCH transmission. Part of the URS sequence r(m) is mapped in the complex value demodulation symbol a^{(p)}_{k,l} as follows.

$$\begin{matrix} {a}_{k , l}^{( p )} = {w}_{p} ( {l}^{′} ) \cdot r ( 3 \cdot {l}^{′} \cdot {N}_{RB}^{max , DL} + 3 \cdot {n}_{PRB} + {m}^{′} ) \\ where & Equation 4 \\ {w}_{p} ( i ) = \{ \begin{matrix}{\overline{w}}_{p} ( i ) & ( {m}^{′} + {n}_{PRB} ) mod 2 = 0 \\ {\overline{w}}_{p} ( 3 - i ) & ( {m}^{′} + {n}_{PRB} ) mod 2 = 1\end{matrix} & \\ k = 5 {m}^{′} + {N}_{sc}^{RB} {n}_{PRB} + {k}^{′} & \\ {k}^{′} = \{ \begin{matrix}1 & p ∈ \{ 7 , 8 , 11 , 13 \} \\ 0 & p ∈ \{ 9 , 10 , 12 , 14 \}\end{matrix} & \\ l = \{ \begin{matrix}{l}^{′} mod 2 + 2 & \begin{matrix}if in a special subframe with \\ configuration 3 , 4 , or 8 \\ ( see Table 4.2 \text{-} 1 )\end{matrix} \\ {l}^{′} mod 2 + 2 + 3 ⌊ {l}^{′} / 2 ⌋ & \begin{matrix}if in a special subframe with \\ configuration 1 , 2 , 6 , or 7 \\ ( see Table 4.2 \text{-} 1 )\end{matrix} \\ {l}^{′} mod 2 + 5 & if not in a special subframe\end{matrix} & \\ {l}^{′} = \{ \begin{matrix}0 , 1 , 2 , 3 & \begin{matrix}if {n}_{s} mod 2 = 0 and in a special subframe with \\ configuration 1 , 2 , 6 , or 7 ( see Table 4.2 \text{-} 1 )\end{matrix} \\ 0 , 1 & \begin{matrix}if {n}_{s} mod 2 = 0 and not in a special subframe \\ with configuration 1 , 2 , 6 , or 7 ( see Table 4.2 \text{-} 1 )\end{matrix} \\ 2 , 3 & \begin{matrix}if {n}_{s} mod 2 = 1 and not in a special subframe \\ with configuration 1 , 2 , 6 , or 7 ( see Table 4.2 \text{-} 1 )\end{matrix}\end{matrix} & \\ {m}^{′} = 0 , 1 , 2 & \end{matrix}$$

Sequence w̅ₚ(i) is given in the normal CP as the following table.

TABLE 2

| (Antenna port p) | [ w̅ₚ(0) w̅ₚ(1) w̅ₚ(2) w̅ₚ(3)] |
|---|---|
| 7 | [+1 +1 +1 +1] |
| 8 | [+1 −1 +1 −1] |
| 9 | [+1 +1 +1 +1] |
| 10 | [+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

That is, the constitution of the URS is determined by the cell ID, scrambling ID, the antenna port, etc.

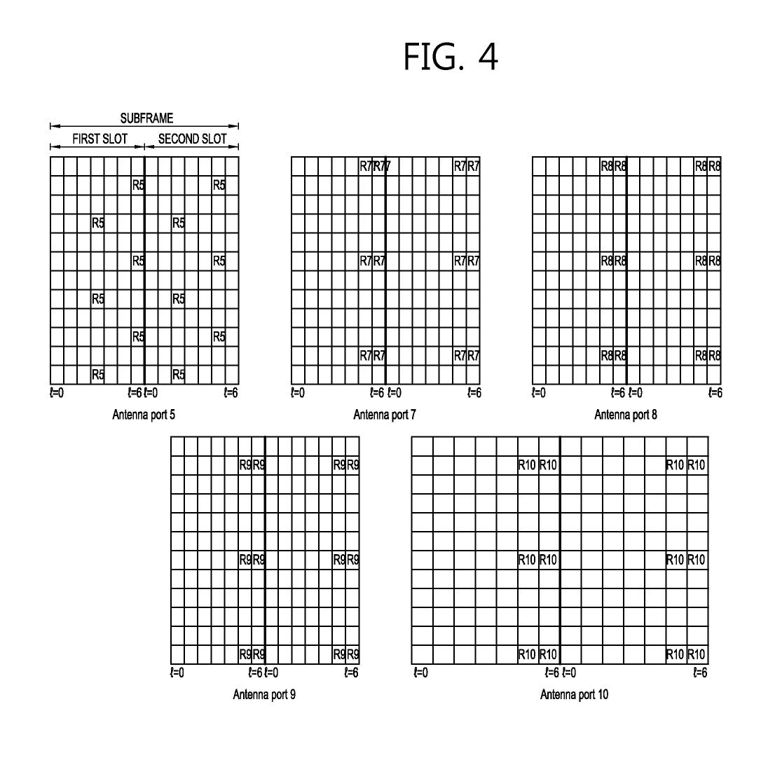

FIG. 4 shows an example of RB to which URS is mapped and shows DM-RS as an example of the URS.

FIG. 4 shows resource elements used for DM-RS in the normal CP structure. Rp denotes a resource element used in DM-RS transmission on antenna port P. For example, R5 indicates a resource element transmitted by DM-RS for antenna port 5. Furthermore, referring to FIG. 4, DM-RS for antenna ports 7 and 8 is transmitted through resource elements corresponding to first, sixth and eleventh subcarriers (subcarrier indexes 0, 5, and 10) of sixth and seventh OFDM symbols (OFDM symbol indexes 5 and 6) of each slot. The DM-RS for antenna ports 7 and 8 may be distinguished by the orthogonal sequence of length 2. The DM-RS for antenna ports 9 and 10 is transmitted through resource elements corresponding to second, seventh and twelfth subcarriers (subcarrier indexes 1, 6, and 11) of sixth and seventh OFDM symbols (OFDM symbol indexes 5 and 6) of each slot. The DM-RS for antenna ports 9 and 10 may be distinguished by the orthogonal sequence of length 2. Furthermore, S={7,8,11,13} or S={9,10,12,14}, and thus DM-RS for antenna ports 11 and 13 is mapped to the resource element where DM-RS for antenna ports 7 and 8 is mapped, and the DM-RS for antenna ports 12 and 14 is mapped to the resource element where the DM-RS for antenna ports 9 and 10 is mapped.

Furthermore, in 3GPP Rel-11 or higher system, the multi-node system including a plurality of connection nodes for performance improvement like FIG. 1 is introduced. Furthermore, the standardization work for applying various MIMO schemes and cooperative communication schemes which are under development and can be applied in the future is under progress.

Due to the node introduction, an introduction of a new control channel for applying various cooperative communication schemes to a multi-node environment is being requested. The control channel, about which a new introduction is being discussed, is enhanced-PDCCH (E-PDCCH).

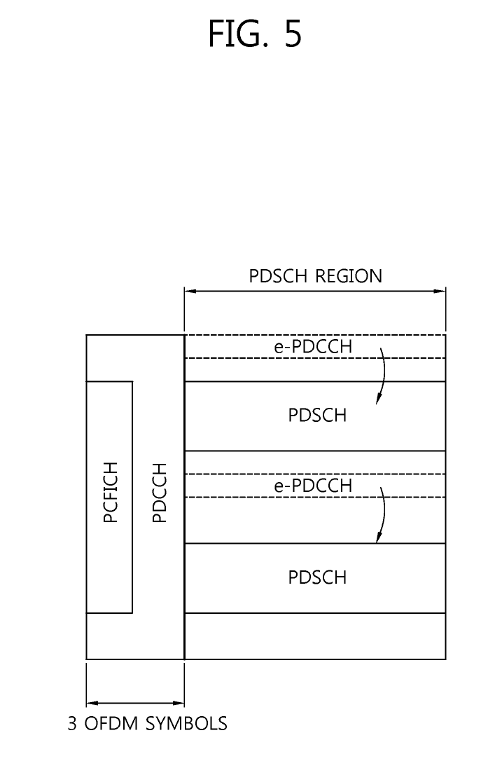

FIG. 5 shows an example of E-PDCCH.

The allocation location of the E-PDCCH may be within the data region (PDSCH region) other than the existing control region (PDCCH region). The control information for the node may be transmitted for each UE through the E-PDCCH, and thus the lacking problem of the existing PDCCH region may be resolved.

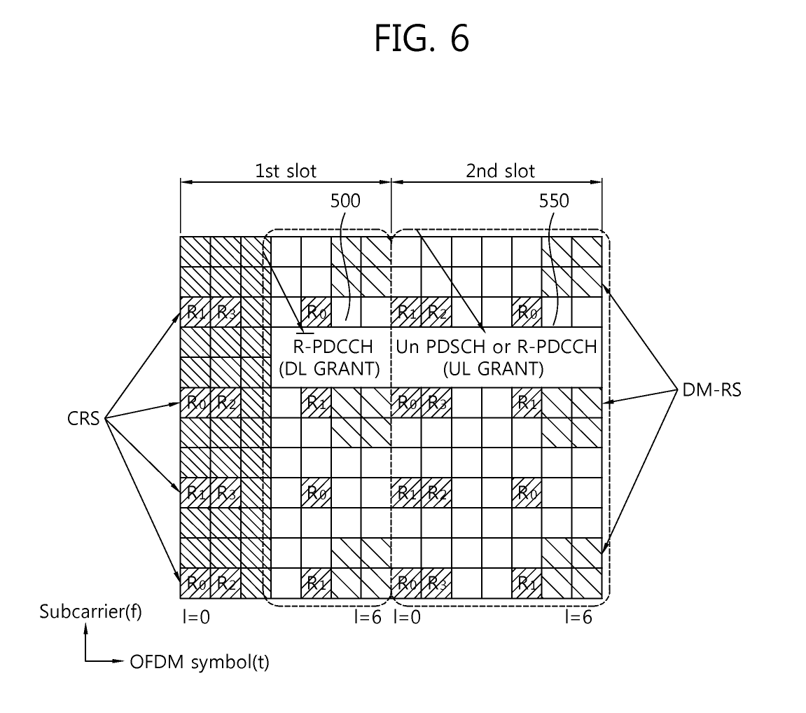

The E-PDCCH is not provided to UEs which are operated by the existing 3GPP rel 8-10, and may be searched by the UE which operates in Rel 11 or higher version. Further, part of the PDSCH region is allocated so as to be used. For example, the E-PDCCH may define part of the PDSCH which generally transmits data as in FIG. 6 so as to be used. The UE may perform blind decoding in order to detect the UE's own E-PDCCH. The E-PDCCH may perform the same scheduling operation as that of the existing PDCCH, i.e., the PDSCH or PUSCH scheduling operation.

The structure of the existing R-PDCCH structure may be reused in a specific allocation scheme of the E-PDCCH. This is to minimize the impact which occurs when the already standardized standard is changed.

FIG. 6 shows an example of the existing R-PDCCH.

In the frequency division duplex (FDD) system, only the DL grant is allocated in the first slot of the resource block, and the UL grant or data (PDSCH) may be allocated in the second slot. At this time, R-PDCCH is allocated to the data RE except all of the PDCCH, CRS, and URS. All of URS and CRS may be used in the R-PDCCH modulation as in Table 3.

When the URS is used, antenna port 7 and scrambling ID=0 is used. On the other hand, when using the CRS, antenna port 0 is used only when the number of the PBCH transmission antennas is 1, and all of antenna ports {0 to 1} and {0 to 3} may be used by converting to the transmission diversity mode when the number of PBCH transmission antennas is 2 or 4.

TABLE 3

| Transmission | DCI | Transmission scheme of PDSCH corresponding |
|---|---|---|
| mode | format | to R-PDCCH |
| Mode 8 | DCI | When R-PDCCH is demodulated based on URS: |
| | format | Single antenna port: antenna port 7 and |
| | 1A | n_{SCID} = 0 is used. |
| | | When R-PDCCH is demodulated based on CRS: |
| | | If the number of PBCH antenna ports is 1, a single |
| | | antenna port, i.e., antenna port 0, is used. |
| | | Otherwise, the transmission diversity is used. |
| | DCI | Dual layer transmission by antenna ports 7 and 8; |
| | format | Or signal antenna port by antenna port 7 or 8 |
| | 2B | |
| Mode 9 | DCI | When R-PDCCH is demodulated based on URS: |
| | format | Single antenna port: antenna port 7 and |
| | 1A | n_{SCID} = 0 is used. |
| | | When R-PDCCH is demodulated based on CRS: |
| | | If the number of PBCH antenna ports is 1, a single |
| | | antenna port, i.e., antenna port 0, is used. |
| | | Otherwise, the transmission diversity is used. |
| | DCI | Up to 4 layer transmissions are used: antenna ports |
| | format | 7 to 10 |
| | 2C | |

<Operation Method of E-PDCCH>

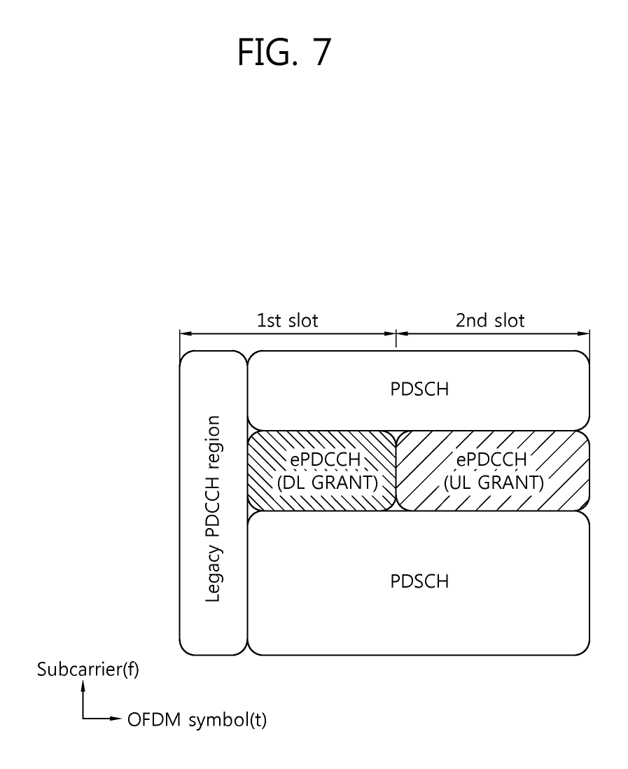

FIG. 7 shows an example of separating and allocating a DL grant and a UL grant for each slot. The case where the E-PDCCH is formed at both the first slot and the second slot within the subframe is assumed.

Referring to FIG. 7, the DL grant is allocated to the first slot of the subframe, and the UL grant is allocated to the second slot.

The DL grant means DCI formats for transmitting downlink control information of the UE, for example, DCI formats 1, 1A, 1B, 1C, 1D, 2, and 2A. The UL grant means DCI formats including control information associated with the uplink transmission of the UE, for example, DCI formats 0 and 4.

The UE is divided into a DL grant and a UL grant which need to be searched for each slot within the subframe. Hence, blind decoding for finding the DL grant is performed by forming a search space within the first slot, and blind decoding for finding the UL grant is performed in the search space formed in the second slot.

In the LTE, there are modes 1 to 9 in the downlink transmission mode, and there are modes 1 to 2 in the uplink transmission mode. Each transmission is set for each UE through the upper layer signaling. In the downlink transmission mode, there are two DCI formats which need to be found by each UE for each set mode. On the other hand, in the uplink transmission mode, the number of DCI formats, which need to be found by each UE, is 1 or 2. For example, in the uplink transmission mode 1, the DCI format 0 corresponds to UL grant, and in the uplink transmission mode 2, the DCI formats 0 and 4 correspond to the UL grant.

In the case of FIG. 7, the number of times of blind decoding, which needs to be performed to detect the UE's E-PDCCH in the search space formed for each slot, is as follows.

DL grant: (number of PDCCH candidates)×(number of DCI formats for downlink transmission mode)=16×2=32.

UL grant: (number of PDCCH candidates in uplink transmission mode 1)×(number of DCI formats in uplink transmission mode 1)=1×1=16 or (number of PDCCH candidates in uplink transmission mode 2)×(number of DCI formats in uplink transmission mode 2)=16×2=32.

Hence, the total number of times of blind decoding, which is generated by combining the number of times of blind decoding in the first slot and the number of times of blind decoding in the second slot, is 32+16=48 in the uplink transmission mode 1, and 32+32=64 in the uplink transmission mode 2.

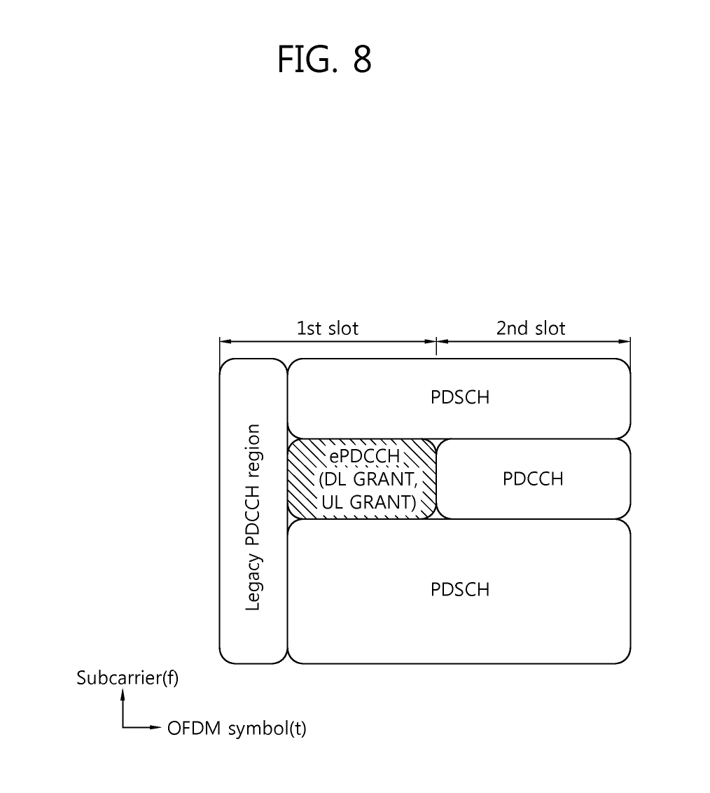

FIG. 8 shows an example of simultaneously allocating a DL grant and a UL grant for a first slot. The case where the E-PDCCH is formed only in the first slot of the subframe is assumed.

Referring to FIG. 8, when allocating the E-PDCCH, the DL grant and the UL grant may be simultaneously allocated to the first slot of the subframe. Hence, the DL grant and the UL grant simultaneously exist in the E-PDCCH of the first slot. The UE performs blind decoding for detecting the DL grant and the UL grant only in the first slot.

In the LTE, DCI formats, which need to detected, are determined according to the transmission mode which is set for each UE. In particular, a total of 2 DCI formats may be detected for each downlink transmission mode, and DCI format 1A is basically included in all downlink transmission modes in order to support the fall-back mode.

In the UL grant, the DCI format 0 has the same length as that of the DCI format 1A, and may be distinguished through a 1 bit flag. Hence, the additional blind decoding is not performed. However, DCI format 4, which is the remaining one among the UL grants, needs to perform the additional blind decoding.

In the case of FIG. 8, the number of times of blind decoding, which needs to be performed to search for the UE's E-PDCCH in the search space, is as follows.

DL grant: (number of PDCCH candidates)×(number of DCI formats for downlink transmission mode)=16×2 =32.

UL grant: (number of PDCCH candidates in uplink transmission mode 1)×(number of DCI formats in uplink transmission mode 1)=0 or (number of PDCCH candidates in uplink transmission mode 2)×(number of DCI formats in uplink transmission mode 2)=16×1=16.

Hence, the total number of times of blind decoding is 32+0=32 in the uplink transmission mode 1, and 32+16=48 in the uplink transmission mode 2.

<Cross-interleaving of E-PDCCH>

Similarly to R-PDCCH, the cross-interleaving (hereinafter, simply referred to as “interleaving”) may also be applied in the E-PDCCH. In a state where a common PRB set which is common to a plurality of UEs is set, a plurality of UEs' E-PDCCH may be interleaved to the frequency domain or time domain.

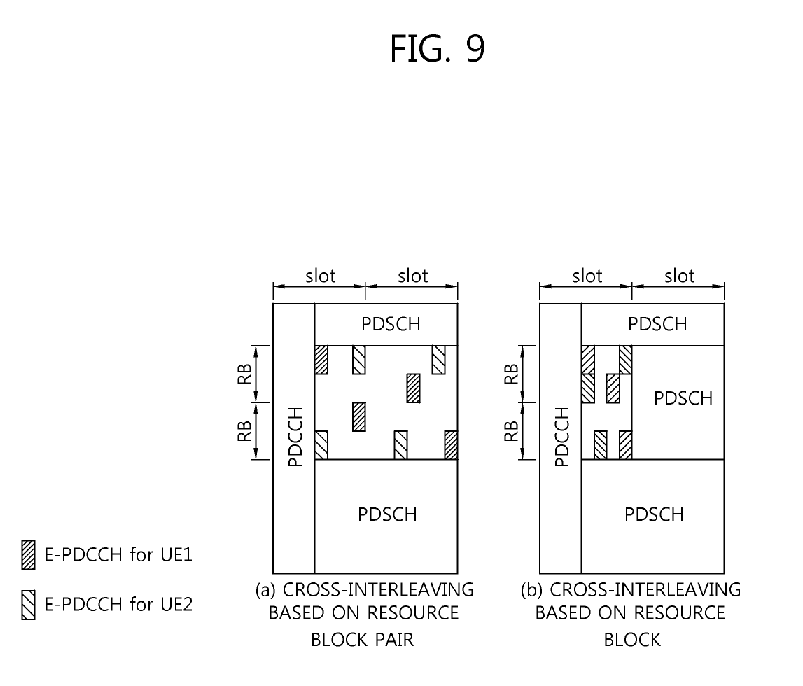

FIG. 9 shows examples of interleaving of E-PDCCH.

FIG. 9A shows an example of performance of cross-interleaving based on a resource block pair, and FIG. 9B shows an example of performance of cross-interleaving based on a resource block.

As illustrated in FIG. 9, a plurality of E-PDCCHs for a plurality of UEs may be distributed and allocated in the time domain and frequency domain. If such cross-interleaving is used, the frequency/time diversity may be obtained throughout the plurality of resource blocks, and thus the diversity gain may be obtained.

Unlike the CRS-based PDCCH, the URS-based PDCCH (i.e., the above-described E-PDCCH) may be decoded through the URS which is generated based on different antenna ports and sequences for each UE.

Furthermore, the E-PDCCH may be mapped to the wireless resource in a cross-interleaved form or may be mapped to the wireless resource in a form that is not cross-interleaved. The form, which is not cross-interleaved, is a form in which wireless resources are locally allocated, and the cross-interleaved form is a form in which the wireless resource is allocated in a distributed manner. Hereinafter, the region where the cross-interleaved E-PDCCH is allocated is called the interleaving region, and the region where the non-cross-interleaved E-PDCCH is allocated is called a non-interleaving region.

Each of the interleaving region and the non-interleaving region may be determined using the physical resource block (PRB), the virtual resource block (VRB), or slot as allocation units. The VRB is a resource block which has the same size as that of the PRB and is distinguished by the logical index. Furthermore, each of the interleaving region and the non-interleaving region may be determined using the partitioned resource blocks, which are generated by partitioning PRB and VRB, as allocation units. That is, a new allocation unit other than the existing resource block may be used.

In the non-interleaving region, the allocation unit may be used according to the aggregation level of the E-PDCCH. For example, if the allocation unit is the slot in the non-interleaving region, in the group level {1, 2, 4, 8} of E-PDCCH, the E-PDCCH may be composed of 1, 2, 4, or 8 slots.

Likewise, if the allocation unit is the partial resource block which is generated by dividing the resource block into N parts, the group level of the E-PDCCH indicates the number of partial resource blocks which may form the E-PDCCH. If the group level is {1, 2, 4, 8}, the E-PDCCH may be composed of 1, 2, 4, or 8 partial resource blocks. For example, N may be 4. At this time, if the group level is greater than 4, one more resource block is used.

If the E-PDCCH is allocated using the partial resource blocks, which are generated by dividing the resource block into N parts, as units, the group level may be a set other than {1, 2, 4, 8}. For example, when N is 4, the group level may be set to {1, 2, 4} or {1, 2, 3, 4}. Likewise, if the group level is redefined, all group levels may be provided in one resource block.

In the interleaving region, the smallest group level of the E-PDCCH may be formed of the minimum 2 resource blocks, slots, or partial resource blocks.

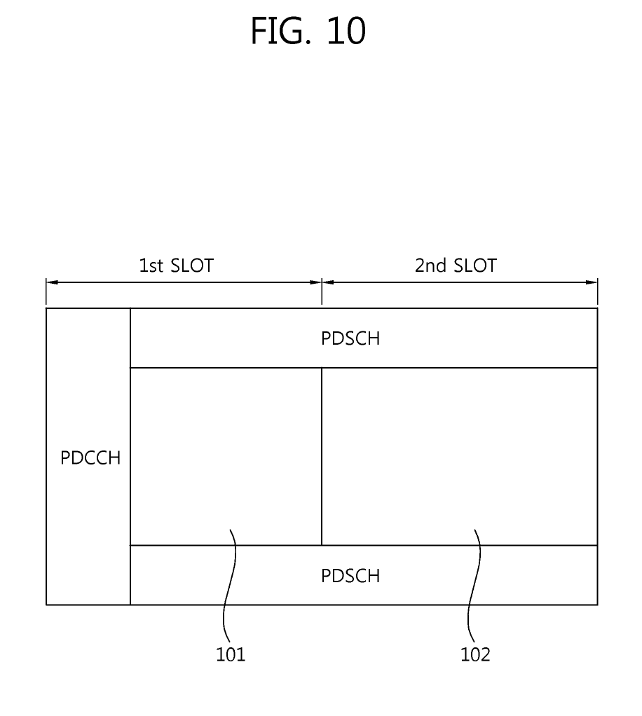

FIG. 10 shows an example where a non-interleaving region and an interleaving region are divided in slot units in E-PDCCH region.

Referring to FIG. 10, the non-interleaving region 101 may be positioned at the first slot, and the interleaving region 102 may be positioned at the second slot. However, the non-interleaving region and the interleaving region have been illustrated within the same subframe for the convenience of description, but the present embodiment is not limited to the example. That is, the non-interleaving region and the inter-leaving region may be included in different subframes. For example, one of the two same resource block regions of the subframe may be the non-interleaving region, and the other may be the interleaving region. Furthermore, the non-interleaving region and the interleaving region may be divided in the units of PRB, VRB, and partial resource blocks.

In the non-interleaving region, one E-PDCCH may not be mixed with another E-PDCCH in the slot, resource block, or partial resource block except the multiplexing in the space level (or layer level). Hence, a unique URS may be provided for each UE. That is, at least one of the antenna port number and the sequence may be set unique for each UE. For example, one of cell ID (N^{cell}_{ID}) and scrambling ID (n_{SCID}), which are used in the URS sequence, may be substituted by the UE's unique identifier C-RNTI (cell-RNTI).

Furthermore, in the non-interleaving region, if the multiplexing of the E-PDCCH with another E-PDCCH or PDSCH in the space level (or layer level) is allowed, using a unique URS for each UE is not appropriate. When decoding the E-PDCCH, if it is possible to sense whether there is another E-PDCCH or PDSCH, the receiving performance may be improved. Hence, it is appropriate to form the URS in order to detect whether there is another E-PDCCH or PDSCH.

In the interleaving region, a plurality of E-PDCCHs need to share the URS, and thus the number of antenna ports, the antenna port no., cell ID, scrambling ID, etc. may be common to all UEs.

Hereinafter, the method of providing the URS in the first region (e.g., the non-interleaving region) and the second region (e.g., the interleaving region), which are distinguished according to the resource allocation scheme of the E-PDCCH, and the method of detecting/decoding the E-PDCCH using the URS will be described.

I. URS in the first region

At least one of the parameters used in generating the URS allocated to the first region (e.g., the non-interleaving region) has a plurality of values. The parameters may be an antenna port number, cell ID, and scrambling ID. The plurality of values may be predetermined for parameters having a plurality of values and may be notified to the UE by the base station using RRC signaling, etc.

For example, in (X, Y), it is assumed that X denotes the antenna port number, and Y denotes the scrambling ID (n_{SCID}). Then the URS allocated to the first region may determine the combination of the antenna port number and the scrambling ID in advance as in 1) to 3) or may be notified by the base station to the UE through RRC signaling, etc.

1) The (X, Y) may be given like (7, 0), (7, 1), (8, 0), and (8, 1) for 4 quasi-orthogonal URSs.

2) The (X, Y) may be given like (7, 0) and (7, 1) for two quasi-orthogonal URSs.

3) The (X, Y) may be given like (7, 0) and (8, 0) for two quasi-orthogonal URSs.

In the above example, the combination of the antenna port number and the scrambling ID is determined or signaled, but the present embodiment is not limited to the example. That is, only one of the antenna port number and the scrambling ID may be predetermined or RRC-signaled. At this time, the {7, 8} may be applied for the antenna port number, and {0, 1} may be applied for the scrambling ID.

If the URS is used to decode the E-PDCCH in the first region, the UE may search for URSs in consideration all combinations of values which the above-described parameters may have. For example, when the {7, 8} is given as the antenna port number, the E-PDCCH decoding may be attempted using each URS by searching for two URSs. As described above, the parameter of the URS takes a plurality of values in order to allow the E-PDCCHs to be multiplexed in the space level (or layer level).

II. The first region's E-PDCCH decoding URS and PDSCH multiplexing is assumed.

In the first region, if the E-PDCCHs are multiplexed in the layer level, the PDSCH may be multiplexed in the layer level. The UE may assume whether the E-PDCCH is multiplexed in the scheduled PDSCH according to the URS which is used in detecting the E-PDCCH.

For example, the URS for the E-PDCCH, which may be used in the UE in the first region, may include the following parameter value. When cell ID=1, scrambling ID=0, and antenna port ∈ {7,8}, the URS, which may be used in decoding the E-PDCCH, is that cell ID=1, scrambling ID=0, and the first URS generated by antenna port 7, and cell ID=1, scrambling ID=0, and the second URS generated by antenna port 8.

At this time, if the UE has detected the E-PDCCH using the second URS, it may be assumed that the PDSCH, which is scheduled by the E-PDCCH, has been multiplexed with the PDSCH based on the first URS.

On the other hand, if the UE has detected the E-PDCCH using the first URS, it cannot be assumed that the PDSCH, which is scheduled by the E-PDCCHl, has been multiplexed with the PDSCH based on the second URS.

That is, if the E-PDCCH is detected using the second URS, the UE may recognize that the E-PDCCH has been multiplexed with another E-PDCCH (E-PDCCH using the first URS), and thus it is assumed that the PDSCH has also been multiplexed with the PDSCH based on the first URS. On the other hand, if the E-PDCCH is detected using the first URS, it is difficult to determine whether the E-PDCCH has been multiplexed with another E-PDCCH (E-PDCCH that uses the second URS), and thus it cannot be assumed that the PDSCH has also been multiplexed.

In the above example, the URSs for the E-PDCCH, which may be used by the UE in the first region, use different antenna port numbers, but it is possible that the URSs use different scrambling IDs.

That is, if cell ID=1 and (antenna port, scrambling ID) ∈ {(7,0), (7,1)}, the URS, which may be used in decoding the E-PDCCH, becomes the first URS which is generated by cell ID=1, antenna port 7, scrambling ID=0, and the second URS which is generated by cell ID=1, antenna port 7, and scrambling ID=1.

In this case, if the E-PDCCH is detected by the second URS, the UE may assume that the PDSCH indicated by the E-PDCCH has been multiplexed with the PDSCH based on the first URS. On the other hand, the UE, which has detected the E-PDCCH using the first URS, cannot assume that the PDSCH has been multiplexed with the PDSCH based on the second URS.

The first URS and the second URS may be predetermined or RRC-signaled.

III. URS in the second region

Parameters, which are used in generating the URS allocated to the second region (e.g., the interleaving region), may respectively have one value or only some of the parameters may have two values. The parameter value may be predetermined or signaled or derived by the RRC message, etc.

For example, the cell ID, scrambling ID, and antenna port number, which are used in generating the URS allocated to the second region, may respectively have one value.

Furthermore, the cell ID and the scrambling ID, which are used in generating the URS allocated to the second region, may have one value, and the antenna port number may have two values. If two or more parameters may respectively have two values, the number of combinations of the two parameters may be set to 2. For example, if the cell ID has one value and the scrambling ID and the antenna port respectively have two values, a total of 4 combinations are possible, but only two combinations are set to be used.

Furthermore, the parameters, which use the URS allocated to the second region, may be derived from the parameters which generate the URS allocated to the first region.

For example, the value of the parameter having one value among parameters, which generate the URS allocated to the first region, may be used in the same manner when generating the URS allocated to the second region. For example, if cell ID=1 and the scrambling ID=0 are set in the parameters for generating the URS in the first region, the cell ID=1 and the scrambling ID=0 may be set in the parameters for generating the URS in the second region.

If there is a parameter, which may have a plurality of values, among parameters for generating the URS allocated to the first region, and the parameter is used in generating the URS allocated to the second region, one of the two methods may be used as follows.

1. One value such as the first value, the smallest value or the largest value among the plurality of values may be applied in generating the URS allocated to the second region. 2. Two values among the plurality of values are applied in generating the URS allocated to the second region. At this time, the two values may be {first value and second value} or {smallest value, the largest value}.

Unlike the above example, the base station may transmit the parameter values (one value or two values), which are used in generating the URS allocated to the second region, directly to the UE through RRC signaling.

As described above, the number of the parameter combinations of the URS allocated to the second region, for example, (antenna port, scrambling ID, cell ID) combinations, may be one or two. It may be assumed that the number of parameter combinations of the URS allocated to the second region may be indicated through RRC signaling or the number may be the same as the number of parameter combinations of the URS of the first region.

If the number of URS parameter combinations of the second region is 2, the UE performs decoding using the URS which is generated with the E-PDCCH transmitted in SFBC and STBC schemes as two combinations in the second region.

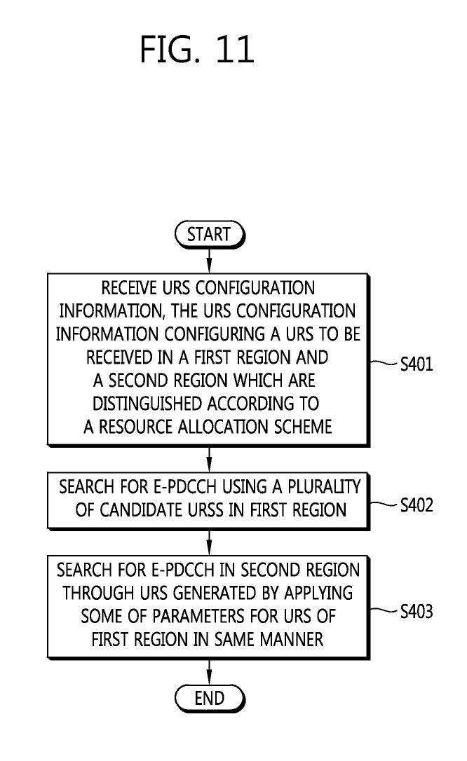

FIG. 11 shows a scheme of searching for E-PDCCH of a UE according to an embodiment of the present invention. FIG. 11 is an example of a method of searching for the E-PDCCH to which the above I to III has been applied.

The UE receives URS setting information which indicates the setting of URSs to be received in the first region and the second region which are distinguished according to the resource allocation scheme (S401). The first region may be the non-interleaving region, and the second region may be the interleaving region. The URSs may be used in decoding the E-PDCCH.

The URS setting information may distinguish the parameter, which is commonly used in the first region and the second region, from the parameter, which is uniquely used in each region, and notify the UE of the parameter information.

Table below is an example of the URS setting information.

TABLE 4

| UE-specific-RS-EPDCCH-Config ::= { | |
|---|---|
| ... | |
| RegionCommon | { |
| ... | |
| Cell-ID | |
| ... | |
| } | |
| Region1dedicated | { |
| ... | |
| AntennaPorts | |
| Scrambling-ID | |
| ... | |
| } | |
| Region2dedicated | { |

```
    ...
    AntennaPorts
    Scrambling-ID
    ...
  }
  ...
}
```

In Table 4 above, “RegionCommon” reveals the value of the parameter (cell ID as an example) which is commonly used in the first region and the second region. “Region1dedicated” notifies the values of unique parameters (antenna port, scrambling ID as examples) to the first region, and “Region2dedicated” notifies unique parameters (antenna port, scrambling ID as examples) to the second region.

The UE searches for the E-PDCCH by searching for a plurality of URSs in the first region (S402), and searches for the E-PDCCH in the second region through the URS which is generated by applying some of the parameters for the URS of the first region in the same manner (S403).

In the above-described examples, the second region, i.e., the interleaving region, may be divided into the first interleaving region and the second interleaving region. That is, when the interleaving region is divided into two regions, the E-PDCCH region may be divided into three regions of the first region (non-interleaving region), the second region (first interleaving region), and the third region (second interleaving region).

The first interleaving region may be used to resolve ambiguity while cell-specific information is transmitted or RRC setting is applied to the UE. The second interleaving region may be used when node-specific information is transmitted or there is a problem in the reliability of the feedback information for closed loop-MIMO operation.

The cell ID, which is used when generating URS in the second interleaving region, may be a value other than that of the cell ID which is used when generating the URS in the first region and the first interleaving region. For example, when generating the URS in the second interleaving region, the physical cell ID (PCI) may be used. Furthermore, the cell ID used when generating the URS in the second interleaving region may use a value received through RRC signaling.

The URS of the first interleaving region (second region) and the second interleaving region (third region) may operate the number of antenna ports and the antenna port No. in the same manner except the reference signal sequence. In this case, the URS setting information may constituted as the following Table 5.

TABLE 5

| ... | |
|---|---|
| Region1-2dedicated | { |
| ... | |
| Cell-ID | |
| ... | |
| } | |
| Region3dedicated | { |
| ... | |
| Cell-ID | |
| ... | |
| } | |
| Region1dedicated | { |
| ... | |
| AntennaPorts | |
| Scrambling-ID | |
| ... | |
| } | |
| Region2-3dedicated | { |

```
    ...
    AntennaPorts
    Scrambling-ID
    ...
  }
  ...
}
```

In Table 5, “Region1-2dedicated” reveals the value of a parameter (e.g., cell ID) which is common to the first region and the second region. The “Region3dedicated” reveals the value of the parameter (e.g., cell ID) which is unique to the third region. The “Region1dedicated” reveals the value of the parameter (e.g., antenna port, scrambling ID) which is unique to the first region, and “Region2-3dedicated” reveals the value of the common parameter (e.g., antenna port, scrambling ID) which is common to the second region and the third region.

In all the above examples, the scrambling ID may be predetermined as 0. In this case, the in the URS setting information, the information on the scrambling ID may be omitted.

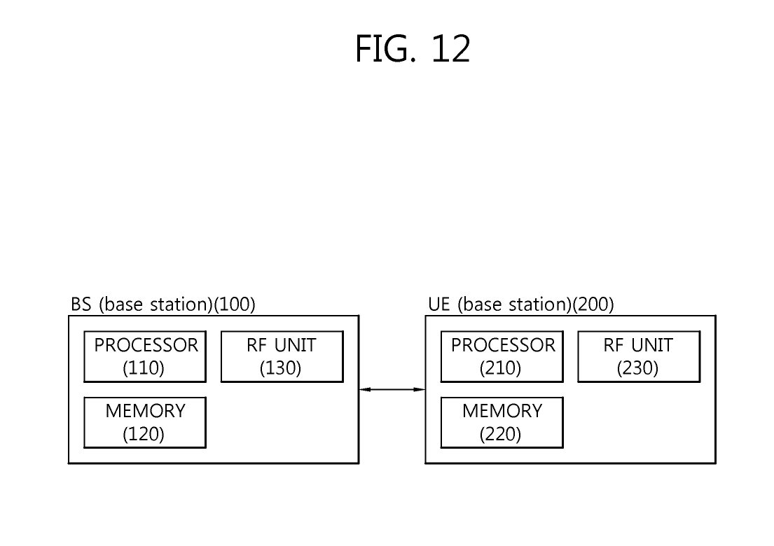

FIG. 12 is a block diagram showing a wireless device to which an embodiment of the present invention may be applied.

The base station 100 includes a processor 110, a memory 120, and a radio frequency unit (RF unit) 130. The processor 111 implements the suggested function, process, and/or method. The layers of the wireless interface protocol may be implemented by the processor 110. The memory 120 is connected to the processor 110 and stores various information sets for operating the processor 110. The RF unit 130 is connected to the processor and receives transmits and/or receives wireless signals.

The UE 200 includes a processor 210, a memory 220, and an RF unit 230. The processor 210 implements the suggested function, process, and/or method. The layers of the wireless interface protocol may be implemented by the processor 210. The memory 220 is connected to the processor and stores various information sets for operating the processor 210. The RF unit is connected to the processor 210 and transmits and/or receives wireless signals.

The processor 110 or 210 may include an application-specific integrated circuit (ASIC) and other chipsets, logic circuit and/or data processing device. The memory 120 or 220 may include a read-only memory (ROM), a random access memory (RAM), a flash memory, a memory card, a storage medium, and/or another storage device. The RF unit 130 or 230 may include a baseband circuit for processing wireless signals. When the embodiment is implemented as software, the above-described scheme may be implemented as a module (process, function, etc.) which forms the above-described function. The module may be stored in the memory 120 or 220 and may be executed by the processor 110 or 210. The memory 120 or 220 may exist inside or outside the processor 110 or 210, and may be connected to the processor 110 or 210 in various well-known means.

What is claimed is:

1. A method of detecting for a control channel of a user equipment (UE) in a multi-node system, the method comprising:
receiving UE-specific reference signal (URS) configuration information, the URS configuration information configuring a URS in a first region and a second region which are distinguished according to a resource allocation scheme; and
searching for a control channel in the first region,
wherein the first region is a non-interleaving region where a channel is allocated to a local radio resource, and the second region is an interleaving region where a channel is allocated to a distributed radio resource, and
wherein the UE attempts to detect the control channel using each of a plurality of candidate URSs which can be configured by the URS configuration information.

2. The method of claim 1, wherein the URS configuration information includes values for parameters which are needed in generating a URS which is available in the first region, and
wherein a plurality of values are given to at least one of the parameters.

3. The method of claim 2, wherein the parameters needed in generating the URS include an antenna port number, a cell identifier (ID), and a scrambling ID.

4. The method of claim 1, wherein, if URSs, which can be received in the first region, are a first URS and a second URS and the control channel is detected by the second URS, the UE assumes that a data channel, which is scheduled by the control channel, has been multiplexed with the data channel which can be decoded using the first URS.

5. The method of claim 1, wherein a parameter having one value among the parameters which are used in generating a URS which can be received in the first region, is used in a same manner in generating a URS which can be received in the second region.

6. The method of claim 1, wherein the URS configuration information separately indicates values of parameters which are commonly used in generating the URS in the first region and the second region, and values of parameters which are uniquely used in each of the first region and the second region.

7. The method of claim 1, wherein the URS configuration information is received through a higher layer signal.

8. The method of claim 1, wherein the second region is divided into a region which receives cell-specific information and a region which receives node-specific information.

9. The method of claim 8, wherein a URS, which is received in a region where the node-specific information is received, is generated based on a cell ID other than the cell ID of the first region and a region which receives the cell-specific information.

10. The method of claim 1, wherein the first region and the second region are positioned within a physical downlink shared channel (PDSCH) region among a physical downlink control (PDCCH) region composed of first N (N is a natural number which is one of 1 to 4) symbols, and the PDSCH region composed of the remaining orthogonal frequency division multiplexing (OFDM) symbols, in a subframe including a plurality of OFDM symbols.

11. A user equipment (UE) for detecting of a control channel in a multi-node system, the UE comprising:
a radio frequency (RF) unit which transmits and receives a radio signal; and
a processor which is connected to the RF unit,
wherein the processor is configured for:
receiving UE-specific reference signal (URS) configuration information, the URS configuration information configuring a URS in a first region and a second region which are distinguished according to a resource allocation scheme; and
searching for a control channel in the first region,
wherein the first region is a non-interleaving region where a channel is allocated to a local radio resource, and the second region is an interleaving region where a channel is allocated to a distributed radio resource, and
wherein the UE attempts to detect the control channel using each of a plurality of candidate URSs which can be configured by the URS configuration information.

12. The UE of claim 11, wherein a parameter having one value among the parameters which are used in generating a URS which can be received in the first region, is used in a same manner in generating a URS which can be received in the second region.

13. The UE of claim 7, wherein, if URSs, which can be received in the first region, are a first URS and a second URS and the control channel is detected by the second URS, it is assumed that a data channel, which is scheduled by the control channel, has been multiplexed with the data channel which can be decoded using the first URS.
